(19) United States
(12) Patent Application Publication
(10) Pub. No.: US 2024/0091905 A1
(43) Pub. Date: Mar. 21, 2024

(54) ABRASIVE SLURRY REGENERATION METHOD AND ABRASIVE SLURRY REGENERATION SYSTEM

(71) Applicant: Konica Minolta, Inc., Tokyo (JP)

(72) Inventors: Shin NAKAYAMA, Kokubunji-shi (JP); Atsushi Takahashi, Kokubunji-shi (JP); Kazufumi Yamazaki, Saitama-shi (JP); Akihiro Maezawa, Hino-shi (JP); Sadatoshi Nishibuchi, Akishima-shi (JP); Kenichi Tabata, Tama-shi (JP)

(21) Appl. No.: 18/455,192

(22) Filed: Aug. 24, 2023

(30) Foreign Application Priority Data
Sep. 15, 2022 (JP) 2022-147084

(51) Int. Cl. B24B 57/02; C09G 1/02; C09K 3/14

(52) U.S. Cl. CPC B24B 57/02; C09G 1/02; C09K 3/1463

(57) ABSTRACT

An abrasive slurry regeneration method includes: collecting at least a used abrasive slurry containing an abrasive component and a constituent component of a polishing target object discharged from a polishing machine; inactivating a metal ion dissolved in the used abrasive slurry; dispersing the abrasive component and the constituent component of the polishing target object contained in the used abrasive slurry; separating the dispersed abrasive component and constituent component of the polishing target object to remove the constituent component of the polishing target object; and preparing a regenerated abrasive slurry containing the abrasive component.

### CROSS-REFERENCE TO RELATED APPLICATIONS

The entire disclosure of Japanese Patent Application No. 2022-147084 filed on Sep. 15, 2022 is incorporated herein by reference in its entirety.

### BACKGROUND

### Technical Field

The present invention relates to an abrasive slurry regeneration method and an abrasive slurry regeneration system. More specifically, the present invention relates to an abrasive slurry regeneration method that improves the removal rate of a constituent component of a polishing target object contained in a used abrasive slurry, and so forth.

### Description of the Related Art

Rare earth oxides such as cerium oxide are used as abrasive in precision polishing of glass and chemical mechanical polishing in manufacture of semiconductors. Chemical mechanical polishing in manufacture of semiconductors may be referred to as “CMP”. The abrasive may be referred to as an “abrasive material” or “abrasive grains”. In a finishing step of various products such as optical glass, cover glass of a smartphone and cover glass of a vehicle-mounted display, polishing using cerium oxide is performed. Further, in CMP of silicon oxide films or the like of semiconductors, polishing using cerium oxide is performed.

In polishing of glass or CMP of semiconductors, cerium oxide is generally supplied to a polishing machine as slurry in which fine particles of cerium oxide are dispersed in water or the like. Then, a polishing cloth, a brush or the like is pressed against glass and relatively moved while pressure is applied, so that polishing is performed.

CMP generates, in addition to a physical force, a chemical action when abrasive grains containing cerium oxide and a polishing target object are brought into contact with each other, so that excellent polishing performance is obtained. For this reason, it is important in CMP that the abrasive grains are stably dispersed in the slurry without being aggregated. When the abrasive grains are aggregated in the abrasive slurry and become coarse particles, a possibility that defects such as scratches are generated in the polishing target object by polishing increases. Therefore, from the viewpoint of processing quality too, it is important to stably disperse the abrasive grains in the abrasive slurry.

In CMP of the polishing target object (glass, etc.) containing silicon as a main component, cerium oxide is generally used. Regarding cerium oxide, regions where it is produced are unevenly located (localized) worldwide, and a process for extracting cerium oxide from a mineral containing cerium oxide has a high environmental load. Therefore, it is strongly desired in use of cerium oxide to effectively use the valuable resource.

As a method for effectively using cerium oxide, there is known a method of collecting cerium oxide abrasive from cerium oxide abrasive slurry used in CMP to recycle.

For example, in JP 2015-163430 A, there is disclosed a method of collecting cerium oxide from a waste abrasive material containing, as a main component, cerium oxide generated by polishing a glass substrate. Specifically, the method of collecting cerium oxide having the following steps (i) to (v) is disclosed.
(i) Dilute a waste abrasive material with alkali metal hydroxide of pH 12 or more.
(ii) Generate a sediment containing cerium oxide as a main component, and remove a supernatant.
(iii) Make the sediment weak acidity to neutrality.
(iv) Wash the sediment with an organic solvent.
(v) Dry and pulverize the sediment.

However, in recent years, in order to enhance optical and physical functions, properties and the like in glass, it has been increasing to add various metals or the like, in addition to a substance (e.g., silicon) serving as a base material. In addition, from the viewpoint of increasing the utilization efficiency of cerium oxide, it has been increasing to perform polishing as long as possible before disposal of abrasive particles of cerium oxide. The “utilization efficiency” here refers to the mass of glass to be processed with respect to the mass of cerium oxide abrasive.

Thus, the content of the glass component contained in the used abrasive slurry is increased. As a result, the content of a component such as metal eluted from the glass and/or the content of a component added to the abrasive slurry as necessary increase. Hence, the content of the metal ions in the used abrasive slurry is increased.

In the used abrasive slurry containing a large amount of metal ions, the glass component is likely to have a gelled structure. In addition, the abrasive particles and the glass component easily form aggregates. Therefore, even when a conventionally known technology is applied, it is difficult to efficiently separate the abrasive particles and the glass component from each other. For a method of collecting and recycling abrasive, further improvement is demanded.

### SUMMARY

The present invention has been made in consideration of the above-described problems and situations, and objects thereof include providing an abrasive slurry regeneration method and an abrasive slurry regeneration system that improve the removal rate of a constituent component of a polishing target object contained in used abrasive slurry.

In order to achieve the above-mentioned object(s), the present inventors have studied the causes of the above-mentioned problems, and as a result, they have found that a process of collecting used abrasive slurry, inactivating dissolved metal ions, dispersing and separating an abrasive component and a constituent component of a polishing target object and regenerating abrasive slurry improves the removal rate of a constituent component of a polishing target object contained in abrasive slurry, and thereby have reached the present invention.

That is, the aforementioned object(s) of the present invention is achieved by the following means.

To achieve at least one of the abovementioned objects, according to an aspect of the present invention, there is provided an abrasive slurry regeneration method comprising:

collecting at least a used abrasive slurry containing an abrasive component and a constituent component of a polishing target object discharged from a polishing machine;

inactivating a metal ion dissolved in the used abrasive slurry;

dispersing the abrasive component and the constituent component of the polishing target object contained in the used abrasive slurry;

separating the dispersed abrasive component and constituent component of the polishing target object to remove the constituent component of the polishing target object; and

preparing a regenerated abrasive slurry containing the abrasive component.

To achieve at least one of the abovementioned objects, according to another aspect of the present invention, there is provided an abrasive slurry regeneration system comprising:

a tank where at least a used abrasive slurry containing an abrasive component and a constituent component of a polishing target object discharged from a polishing machine is collected;

a tank from which a component that inactivates a metal ion is supplied to the used abrasive slurry;

a disperser that disperses the abrasive component and the constituent component of the polishing target object contained in the used abrasive slurry;

a separator that separates the abrasive component and the constituent component of the polishing target object contained in the used abrasive slurry to remove the constituent component of the polishing target object; and

a tank from which a component to be contained in a regenerated abrasive slurry is supplied.

Although the expression mechanism or action mechanism of the effects of the present invention is not clear, it is assumed as follows.

In order to efficiently collect the abrasive from the used abrasive slurry, it is necessary to separate the abrasive component and other component(s) in the used abrasive slurry with high accuracy. In the used abrasive slurry, the abrasive component is present as particles and is relatively larger than the other components. Therefore, the abrasive can be efficiently collected by uniformly dispersing the abrasive particles in the used abrasive slurry and then precipitating only the abrasive particles to separate them from the others.

However, in practice, the used abrasive slurry discharged from the polishing machine has a certain degree of viscosity. Therefore, it is difficult to uniformly disperse the abrasive particles in the used abrasive slurry. In addition, in the used abrasive slurry, the abrasive particles and the constituent component of the polishing target object are easily aggregated, and it is difficult to precipitate only the abrasive particles to separate them from the constituent component of the polishing target object.

This is considered to be caused by the action of the abrasive particles, the constituent component of the polishing target object and the metal ions contained in the used abrasive slurry. Specifically, in the presence of the metal ions, the constituent component of the polishing target object is likely to have a gelled structure, and the viscosity of the used abrasive slurry increases. In addition, it is considered that the abrasive particles and the constituent component of the polishing target object are easily aggregated, and thus it is difficult to separate the abrasive particles and the constituent component of the polishing target object.

Examples of the metal ions contained in the used abrasive slurry include metal ions eluted from the constituent component of the polishing target object and metal ions derived from additives and so forth. Further, examples thereof may include metal ions entered during polishing.

In the present invention, these metal ions contained in the used abrasive slurry are inactivated to suppress the action with the abrasive particles and the constituent component of the polishing target object. Further, it is considered that the abrasive can be efficiently collected by dispersing the abrasive component and the constituent component of the polishing target object contained in the used abrasive slurry.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic view showing an example of the flow of basic steps of an abrasive slurry regeneration method;

FIG. 2 is a schematic view showing an example of the flow of steps; and

FIG. 3 is a schematic view showing an example of the flow of steps.

### DETAILED DESCRIPTION

An abrasive slurry regeneration method of the present invention includes: collecting at least a used abrasive slurry containing an abrasive component and a constituent component of a polishing target object discharged from a polishing machine; inactivating a metal ion(s) dissolved in the used abrasive slurry; dispersing the abrasive component and the constituent component of the polishing target object contained in the used abrasive slurry; separating the dispersed abrasive component and constituent component of the polishing target object to remove the constituent component of the polishing target object; and preparing a regenerated abrasive slurry containing the abrasive component.

This feature is a technical feature common to or corresponding to the following embodiments.

As an embodiment of the present invention, from the viewpoint of being able to sufficiently inactivate metal ions, it is preferable to form a complex to inactivate the metal ion(s) dissolved in the used abrasive slurry.

As an embodiment of the present invention, from the viewpoint that the stability of a complex to be formed is high, it is preferable that a chelating agent is added to the used abrasive slurry to form the complex. Furthermore, it is preferable that the chelating agent contain ethylenediaminetetraacetic acid, citric acid, tartaric acid, nitrilotriacetic acid, N,N-bis(2-hydroxyethyl)glycine, and/or salt of any of these.

As an embodiment of the present invention, from the viewpoint of being able to sufficiently inactivate metal ions and being able to suppress aggregation of the abrasive component and the constituent component of the polishing target object, the addition amount of the chelating agent is preferably within the range of 0.2 to 50.0 molar equivalents and further preferably within the range of 0.5 to 10.0 molar equivalents with respect to the total molar amount of the metal ion(s) dissolved in the used abrasive slurry.

As an embodiment of the present invention, from the viewpoint of high dispersibility, it is preferable that ultrasonic wave emission, mechanical stirring and/or pressurization be performed to disperse the abrasive component and the constituent component of the polishing target object contained in the used abrasive slurry.

As an embodiment of the present invention, from the viewpoint of high dispersibility, in the dispersing, the pH value of the used abrasive slurry at 25° C. is preferably within the range of 5 to 11. Further, it is preferable that an acidity regulator is added to the used abrasive slurry to make the pH value of the used abrasive slurry at 25° C. be within the range of 5 to 11. It is further preferable that the acidity regulator is inorganic acid, carboxylic acid, amine base and/or hydroxide.

As an embodiment of the present invention, from the viewpoint of high dispersibility, it is preferable to add a dispersant to the used abrasive slurry in the dispersing. It is further preferable that the dispersant be a water-soluble anionic dispersant, a water-soluble cationic dispersant and/or a water-soluble amphoteric dispersant.

As an embodiment of the present invention, from the viewpoint of high separability, it is preferable that natural sedimentation, centrifugation, coagulation sedimentation with addition of salt, filtration and/or coagulation sedimentation with adjustment of the pH value be performed to separate the abrasive component and the constituent component of the polishing target object contained in the used abrasive slurry.

An abrasive slurry regeneration system of the present invention includes: a tank where at least a used abrasive slurry containing an abrasive component and a constituent component of a polishing target object discharged from a polishing machine is collected; a tank from which a component that inactivates a metal ion(s) is supplied to the used abrasive slurry; a disperser that disperses the abrasive component and the constituent component of the polishing target object contained in the used abrasive slurry; a separator that separates the abrasive component and the constituent component of the polishing target object contained in the used abrasive slurry to remove the constituent component of the polishing target object; and a tank from which a component to be contained in a regenerated abrasive slurry is supplied.

As an embodiment of the present invention, from the viewpoint of high dispersibility, it is preferable that the disperser include a device that emits ultrasonic waves, performs mechanical stirring and/or performs pressurization, and it is further preferable that the disperser be a homogenizer.

As an embodiment of the present invention, from the viewpoint of high separability, it is preferable that the separator performs natural sedimentation, centrifugation, coagulation sedimentation with addition of salt, filtration and/or coagulation sedimentation with adjustment of a pH value to perform the separation.

Although some embodiments of the present invention have been mentioned above, the scope of the present invention is not limited to the embodiments, and includes the scope of claims and the scope of their equivalents.

Hereinafter, the present invention, components thereof, and embodiments and aspects for carrying out the present invention will be described in detail. In the present application, “to” or “-” between numerical values is used to mean that the numerical values written before and after “to” or “-” are included as a lower limit value and an upper limit value.

1. Summary of Abrasive Slurry Regeneration Method

An abrasive slurry regeneration method of the present invention includes: collecting at least a used abrasive slurry containing an abrasive component and a constituent component of a polishing target object discharged from a polishing machine; inactivating a metal ion dissolved in the used abrasive slurry; dispersing the abrasive component and the constituent component of the polishing target object contained in the used abrasive slurry; separating the dispersed abrasive component and constituent component of the polishing target object to remove the constituent component of the polishing target object; and preparing a regenerated abrasive slurry containing the abrasive component.

In the present invention, the “abrasive” refers to fine particles or an aggregate (powder) thereof used for polishing the polishing target object. The abrasive is also referred to as an “abrasive material” or “abrasive grains”. Specific examples and details thereof will be described later.

The “abrasive slurry” refers to a mixture in which at least abrasive particles are suspended in a liquid.

Furthermore, in the present invention, an “unused abrasive slurry” refers to a newly prepared abrasive slurry. The “used abrasive slurry” refers to an abrasive slurry collected after an unused abrasive slurry or a regenerated abrasive slurry is used for polishing. The “regenerated abrasive slurry” refers to an abrasive slurry prepared by recycling the used abrasive slurry.

In the present invention, polishing is performed using the unused abrasive slurry or the regenerated abrasive slurry (polishing step). Hereinafter, the unused abrasive slurry or the regenerated abrasive slurry may be collectively referred to as an “unused or regenerated abrasive slurry”. Thereafter, the used abrasive slurry discharged from a polishing machine is collected (slurry collection step). Next, the metal ions dissolved in the used abrasive slurry are inactivated (inactivation step). The abrasive component and the constituent component of the polishing target object contained in the used abrasive slurry are dispersed (dispersion step). Then, the dispersed abrasive component and the constituent component of the polishing target object are separated (separation step), and the regenerated abrasive slurry containing the abrasive component is prepared (slurry regeneration step).

In the present invention, it is considered that having the inactivation step and the dispersion step improves the removal rate of the constituent component of the polishing target object, in particular.

The abrasive slurry regeneration method of the present invention will be described mainly along the flow of steps. However, this is merely an example, and the present invention is not limited thereto.

2. Steps of Abrasive Slurry Regeneration Method

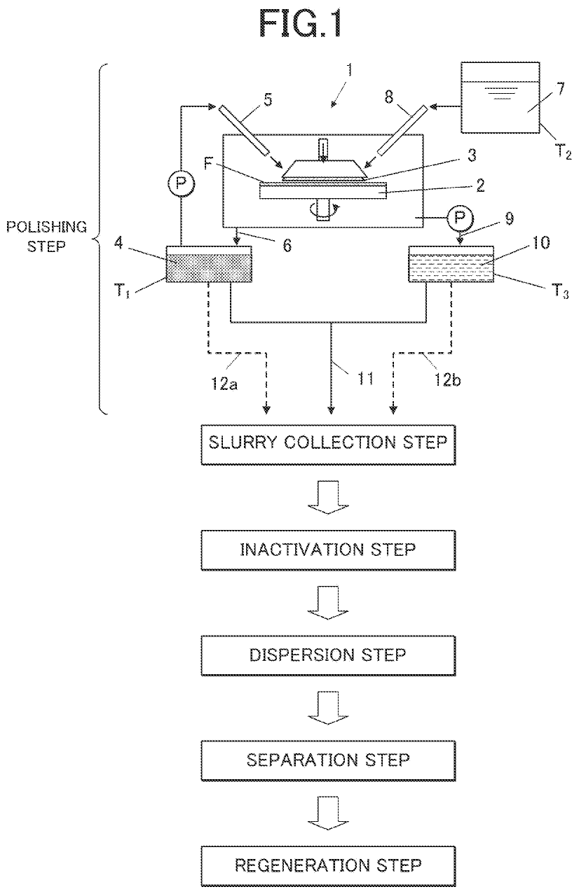

FIG. 1 is a schematic view showing an example of the flow of basic steps of the abrasive slurry regeneration method of the present embodiment.

(1) Polishing Step

In a polishing step, a polishing target object is polished using an abrasive slurry containing an abrasive.

(1.1) Abrasive

In the present invention, the “abrasive” refers to fine particles or an aggregate (powder) thereof used for polishing a polishing target object. The abrasive is also referred to as an “abrasive material” or “abrasive grains”. The abrasive is preferably an aggregate (powder) of inorganic fine particles having a Mohs hardness of greater than 8.

Note that in a narrow sense, the abrasive refers to fine particles or an aggregate (powder) thereof which is composed of only a component having a function of polishing a polishing target object. For example, the abrasive in a narrow sense may be high-purity cerium oxide or the like. Furthermore, in a broad sense, the abrasive refers to fine particles or an aggregate (powder) thereof composed of a component having a function of polishing a polishing target object and another component(s). Examples of the abrasive in a broad sense include bastnaesite.

Generally, as the abrasive for an optical glass, a semiconductor substrate, or the like, inorganic fine particles of red iron oxide (αFe₂O₃), cerium oxide, aluminum oxide, manganese oxide, zirconium oxide, colloidal silica, or the like are preferable. Practically, a slurry is used in which abrasive fine particles are dispersed in water or oil.

In the present invention, it is preferable to use an abrasive containing cerium oxide as a main component, which is applicable to chemical mechanical polishing (CMP). Chemical mechanical polishing (CMP) performs polishing by both physical action and chemical action. Accordingly, in polishing the surface of a semiconductor substrate or glass, a sufficient processing speed can be obtained while flatness is maintained with high accuracy.

As described above, cerium oxide is a precious resource. Therefore, cerium oxide can be more effectively utilized by an abrasive containing cerium oxide as a main component applied to the present invention.

Note that the term “main component of the abrasive” used herein refers to a component whose content is the largest among compound species or element species contained as components constituting the abrasive particles.

Examples of the cerium oxide used as an abrasive include high-purity cerium oxide in which the content of cerium oxide is almost 100 mass %, and bastnaesite. Examples of the high-purity cerium oxide include those manufactured by C. I. Kasei Co., Ltd., those manufactured by Techno Rise Co., Ltd, and those manufactured by Wako Pure Chemical Industries, Ltd.

Bastnaesite is not pure cerium oxide, but is obtained by calcining an ore containing a large amount of rare earth elements other than cerium and then pulverizing the calcined ore. Examples of the rare earth components other than cerium include lanthanum, neodymium, and praseodymium. Fluoride or the like may be contained in addition to oxide.

Components and a shape of the cerium oxide are not particularly limited, but an average particle size (D50) thereof is preferably within the range of several tens of nm to several μm.

As the abrasive according to the present invention, a commercially available abrasive can be used.

In the present invention, the “abrasive component” in a narrow sense refers to a component (compound species or element species) having a function of polishing a polishing target object itself, and includes dissociated ions. The “abrasive component” in a broad sense refers to particles constituted of a component having a function of polishing a polishing target object and another component(s).

For example, if bastnaesite is used as the abrasive, fine particles of bastnaesite contain components other than cerium oxide (for example, lanthanum oxide). Since cerium oxide having a function of polishing a polishing target object is contained, the bastnaesite fine particles correspond to the abrasive component. However, the component(s) other than cerium oxide partially dissolved from the bastnaesite fine particles do not correspond to the abrasive component. In addition, in a case where the bastnaesite fine particles are disintegrated and generate fine particles not containing cerium oxide, the fine particles do not correspond to the abrasive component.

(1.2) Polishing Target Object

In the present invention, it is preferable to use an object containing silicon as a main component as a polishing target object. It is considered that by polishing a polishing target object containing silicon as a main component with an abrasive containing cerium oxide as a main component, the object can be polished by both a physical action and a chemical action.

Here, the “main component of a polishing target object” refers to a component having the largest content among compound species or element species contained as components constituting the polishing target object.

In the present invention, the “constituent component of a polishing target object” refers to a compound species or an element species contained as a component constituting the polishing target object. It also includes ions dissociated from a compound or the like constituting a polishing target object. However, this is limited to those derived from the polishing target object.

For example, in general glass, in addition to silicic acid (SiO₂), soda ash (Na₂CO₃), lime (CaO), or the like may be contained. Soda ash and lime do not contain silicon, but each correspond to the “constituent component of a polishing target object” since they are components constituting glass.

Examples of the polishing target object containing silicon as a main component include an optical glass, a glass substrate for an information recording medium, a cover glass of a smartphone, a cover glass of a vehicle-mounted display, and a silicon wafer.

(1.3) Polishing Step

For example, for polishing a glass substrate, it is preferable that the polishing step include a preparation step of an unused or regenerated abrasive slurry, a polishing process step, and a washing step.

Hereinafter, as an example, the polishing step in which a glass substrate is a polishing target object will be described.

Note that the preparation step of the regenerated abrasive slurry will be described later.

(1.3.1) Preparation Step of Unused Abrasive Slurry

The unused abrasive slurry can be prepared by dispersing powder of an abrasive in a solvent using a dispersant. In addition, an acidity regulator or the like may be further contained as necessary.

The content of the abrasive is preferably within the range of 0.1 to 40 mass % with respect to the total mass of the unused abrasive slurry.

Examples of the method for dispersing the abrasive in a solvent include, in addition to a dispersion treatment with a usual stirrer, a method using a homogenizer (an ultrasonic type, a stirring type or a pressure type) and a method using a wet ball mill.

The unused abrasive slurry can prevent aggregation of the abrasive particles by containing a dispersant. In addition, in order to prevent aggregation or precipitation (sedimentation) of the abrasive particles, it is preferable that the dispersion state be maintained by constant stirring using a stirrer or the like. Specifically, a tank for unused abrasive slurry is installed beside a polishing machine, and a dispersion state in the unused abrasive slurry is always maintained using a stirrer or the like. Next, it is preferable to use a supply pump to circulate and supply the unused abrasive slurry to the polishing machine.

It is also preferable that the regenerated abrasive slurry be circulated and supplied in the same manner.

In addition, in the present invention, a new abrasive slurry for a different purpose or application can be prepared using the regenerated abrasive slurry as an unused abrasive slurry.

For example, a used abrasive slurry used for polishing quartz glass is collected, and a regenerated abrasive slurry for polishing quartz glass is prepared using the present invention. Then, by adding a different additive to this, an unused abrasive slurry for polishing aluminosilicate glass can be made. Furthermore, this is used for polishing aluminosilicate glass and then collected, and by using the present invention, a regenerated abrasive slurry for polishing aluminosilicate glass can be prepared.

As described above, examples of a case where using a regenerated abrasive slurry, a new abrasive slurry for a different purpose or use is prepared as an unused abrasive slurry include a case where a polishing target object is different. Examples thereof further include a case where, in polishing the same product, a plurality of polishing steps such as rough polishing and precision polishing are provided.

(1.3.1.1) Solvent

The solvent is not particularly limited as long as the solvent dissolves or disperses the abrasive, the dispersant, the acidity regulator, and the like.

Examples of the solvent include water, alcohol, acetic acid, acetone, and mixtures thereof. Among these, water is preferable, and examples thereof include pure water, distilled water, deionized water, and ion-exchanged water.

(1.3.1.2) Dispersant

Examples of the dispersant include a water-soluble anionic dispersant, a water-soluble cationic dispersant, and a water-soluble amphoteric dispersant. In addition, a dispersant such as ammonium polyacrylate, a copolymer of acrylic acid amide and ammonium acrylate, or a polyacrylic acid-maleic acid copolymer may be used.

Two or more kinds of dispersants may be used in combination. The dispersant includes, for example, at least one kind of polymer dispersant including an ammonium acrylate salt as a copolymerization component. The dispersant includes, for example, at least one selected from a water-soluble anionic dispersant, a water-soluble cationic dispersant and a water-soluble amphoteric dispersant.

Among these, a water-soluble anionic dispersant, a water-soluble cationic dispersant or a water-soluble amphoteric dispersant is preferable. By using these, the content of the dispersant can be measured and controlled using the value of the electrical conductivity as an index.

Furthermore, in a case where the dispersant is used for polishing in the production of semiconductor elements, the content of metal ions such as sodium ions or potassium ions in the dispersant is preferably 10 ppm or less with respect to the total mass of the unused abrasive slurry.

Examples of the water-soluble anionic dispersant include triethanolamine lauryl sulfate, ammonium lauryl sulfate, triethanolamine polyoxyethylene alkyl ether sulfate, and a polycarboxylic acid type polymer dispersant.

Examples of the polycarboxylic acid type polymer dispersant include acrylic acid; methacrylic acid; maleic acid; fumaric acid; a polymer of a carboxylic acid monomer having an unsaturated double bond, such as itaconic acid; a copolymer of a carboxylic acid monomer having an unsaturated double bond and another monomer having an unsaturated double bond; and sodium salts, ammonium salt and amine salts of these.

Examples of the water-soluble cationic dispersant include first to third aliphatic amines, quaternary ammonium, tetraalkylammonium, trialkylbenzylammonium alkylpyridinium, 2-alkyl-1-alkyl-1-hydroxyethylimidazolinium, N,N-dialkylmorpholinium, polyethylene polyamine fatty acid amide, urea condensates of polyethylene polyamine fatty acid amides, quaternary ammonium of urea condensates of polyethylene polyamine fatty acid amides, salts of these and the like.

The water-soluble amphoteric dispersant is preferably a betaine-based dispersant. Examples of the betaine-based dispersant include betaines such as N,N-dimethyl-N-alkyl-N-carboxymethylammonium betaine, N,N,N-trialkyl -N-sulfoalkyleneammonium betaine, N,N-dialkyl-N, N-bispolyoxyethyleneammonium sulfate betaine, and 2-alkyl-1-carboxymethyl-1-hydroxyethylimidazolinium betaine; and aminocarboxylic acids such as N,N-dialkylaminoalkylenecarboxylate.

The content of the dispersant is preferably within the range of 0.01 to 5.0 mass % with respect to the total mass of cerium oxide. Within this range, the dispersibility of the abrasive particles in the unused abrasive slurry can be improved, and sedimentation can be prevented. In addition, scratches due to polishing can be suppressed.

The molecular weight of the dispersant is preferably within the range of 100 to 50,000, and further preferably within the range of 1,000 to 10,000. Within this range, increase in the viscosity of the unused abrasive slurry can be suppressed, and dispersion stability of the abrasive particles can be improved.

(1.3.1.3) Acidity Regulator

The acidity regulator is not particularly limited. As the acid of the Acidity regulator, inorganic or carboxylic acid is preferable, and as the base, amine base or hydroxide is preferable.

Provided that if a silicon oxide film or the like used in the field of semiconductors is a polishing target object, it is preferable that the acidity regulator contain no metal element.

The pH value can be measured using, for example, a Lacom tester desktop pH meter “pH1500” (manufactured by AS ONE Corporation).

(1.3.2) Polishing Process Step and Washing Step

In FIG. 1, a polishing machine 1 has a polishing platen 2 to which a polishing cloth F is attached, and the polishing platen 2 is rotatable. The polishing cloth F is made of nonwoven fabric, synthetic resin foam, synthetic leather, or the like.

Abrasive liquid 4 may be unused or regenerated abrasive slurry. The abrasive liquid 4 may be abrasive slurry that has already been used for polishing and does not reach the criterion for disposal. The abrasive liquid 4 may be abrasive slurry in a state where these are mixed.

At the time of polishing, the polishing platen 2 is rotated while a polishing target object 3 is pressed against the polishing platen 2 with a predetermined pressing force. At the same time, the abrasive liquid 4 is supplied from a slurry nozzle 5 via a pump. The abrasive liquid 4 is stored in a slurry tank T1 (abrasive slurry supply tank) through a channel 6. In this way, the abrasive liquid 4 repeatedly circulates between the polishing machine 1 and the slurry tank T1.

To the polishing target object 3 immediately after being polished and the polishing machine 1, a large amount of abrasive adheres. Therefore, as illustrated in FIG. 1, washing water 7 is supplied after polishing to wash the abrasive adhering to the polishing target object 3 and the polishing machine 1.

The washing water 7 for washing the polishing target object 3 and the polishing machine 1 is stored in a washing water storage tank T2, and the washing water 7 is blown to a polishing part from a washing water jet nozzle 8 to perform washing. As a result, washing liquid 10 containing the abrasive is stored in a washing liquid storage tank T3 through a channel 9 via a pump. At this time, the washing liquid 10 containing the abrasive is discharged to the outside of the system.

The washing liquid storage tank T3 is a tank for storing the washing liquid 10 (washing water that has been used in washing), and the washing liquid 10 is constantly stirred with a stirring blade in order to prevent sedimentation and aggregation.

The abrasive liquid 4 stored in the slurry tank T1 and used by circulating and the washing liquid 10 containing the abrasive stored in the washing liquid storage tank T3 are both in a state of containing the abrasive component and the constituent component of the polishing target object 3 scraped off by polishing.

The content of the abrasive in the unused or regenerated abrasive slurry is preferably in the range of 0.1 to 40 mass % with respect to the total mass of the unused or regenerated abrasive slurry.

Meanwhile, a certain amount of the abrasive is discharged to the outside of the system in the washing step, so that the abrasive in the system decreases. To compensate for this decrease, abrasive may be added to the slurry tank T1. This addition may be performed every one time of processing or may be performed every certain number of times of processing. The abrasive is preferably supplied in a state of being sufficiently dispersed in a solvent.

(2) Slurry Collection Step

In the slurry collection step, the used abrasive slurry discharged from the polishing machine is collected.

In FIG. 1, the abrasive liquid 4 and the washing liquid 10 containing the abrasive are collected as a mixed liquid of these or as individual liquids. It is preferable that the abrasive liquid 4 be repeatedly used, and collected when reaching the criterion for disposal.

In the present invention, the “used abrasive slurry” refers to abrasive slurry that is unused or regenerated abrasive slurry used for polishing and thereafter collected. To be specific, it refers to the abrasive slurry discharged to the outside from the system constituted of the polishing machine 1, the slurry tank T1 and the washing liquid storage tank T3.

The used abrasive slurry is mainly composed of used abrasive slurry a (life end slurry) and used abrasive slurry b (rinse slurry).

The used abrasive slurry a is abrasive slurry that is stored in the slurry tank T1, used for a certain number of times in polishing and reaches the criterion for disposal, and is disposed of. The criterion for disposal can be appropriately selected according to necessity, for example, the total polishing amount of the polishing target object.

Examples of characteristics of the used abrasive slurry a include the concentration of the polishing target object thereof being higher than that of unused or regenerated abrasive slurry.

The used abrasive slurry b is washing liquid containing the abrasive discharged in the washing step, and is collected as slurry containing the abrasive.

Examples of characteristics of the used abrasive slurry b include the following two.
1) Since it is abrasive slurry discharged in the washing step, a large amount of washing water has flowed therein, and the concentration of the abrasive thereof is lower than that of the used abrasive slurry a.
2) A part of the polishing target object adhering to the polishing cloth or the like has flowed therein.

In the case where they are collected as individual liquids, the used abrasive slurry a is collected from the slurry tank T1 through a channel 12a. In addition, the used abrasive slurry b is collected from the washing liquid storage tank T3 through a channel 12b. In the case where they are collected as a mixed liquid, they are collected from the slurry tank T1 and the washing liquid storage tank T3 through a channel 11.

The present invention is preferably applied to both of the used abrasive slurries a and b, but may be applied to only one of them.

(3) Foreign Substance Removal Step

It is preferable that the abrasive slurry regeneration method of the present invention further include a foreign substance removal step (not illustrated).

In the foreign substance removal step, coarse foreign substances are removed in advance from the collected used abrasive slurry.

The method for removing foreign substances is not particularly limited. For example, it is preferable to perform filtration using a filter having a pore diameter in the range of 20 to 100 μm alone or using filters having different pore diameters as multiple stages (multistage filtration). For multistage filtration, it is preferable, for example, a filter having a diameter of 25 μm and a filter having a diameter of 10 μm be used continuously in combination.

The filter(s) used for filtration is not particularly limited, and examples thereof include a membrane filter, a hollow fiber filter, a metal filter, a bobbin filter, a ceramic filter, and a roll-type polypropylene filter.

Examples of the ceramic filter include a ceramic filter manufactured by TAMI, France, a ceramic filter manufactured by Noritake, a ceramic filter manufactured by NGK Insulators, Ltd, and a ceramic filter manufactured by Pall Cooperation. Examples of the ceramic filter manufactured by NGK Insulators, Ltd. include “Cerarek® DPF” and “Cefilt®”.

(4) Inactivation Step

In the inactivation step, metal ions dissolved in the used abrasive slurry are inactivated.

As described above, it is considered that in the used abrasive slurry, metal ions eluted from the constituent component of the polishing target object and metal ions derived from additives and the like are dissolved. In addition, it is considered that in the used abrasive slurry, metal ions and the like entered during polishing are also dissolved. It is considered that the abrasive can be efficiently collected by inactivating these metal ions.

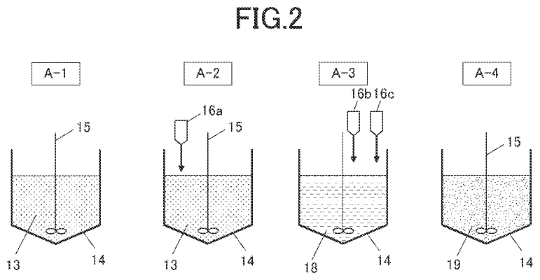

In FIG. 2, steps (A-1) and (A-2) are steps of inactivating metal ions dissolved in the used abrasive slurry collected in the slurry collection step.

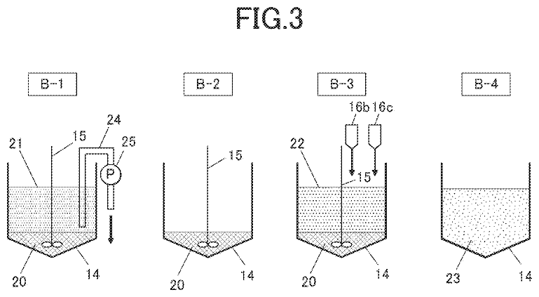

In the step (A-1), used abrasive slurry 13 collected and with foreign matters removed is put into a preparation tank 14 provided with a stirrer 15. Hereinafter, the used abrasive slurry from which the foreign substances have been removed may be referred to as “mother liquid”. FIGS. 2 and 3 show an example in which the preparation tank 14 also serves as tanks used in the slurry collection step, the inactivation step, the dispersion step, the separation step, and the regeneration step.

Next, in the step (A-2), a component that inactivates metal ions is added to the used abrasive slurry 13 from an inactivating component supply tank 16a while stirring is being performed. At this time, water may be added as necessary. As the water, distilled water, purified water, ion exchange water, pure water or the like can be used, but it is preferable to use pure water in which the content of ion components is reduced as much as possible.

Examples of the metal ions dissolved in the used abrasive slurry include Al³⁺, Ca²⁺, Mg²⁺, Na⁺, and K⁺.

The kind and content of the metal ions dissolved in the used abrasive slurry can be measured by the following method. The contents of the abrasive component and the constituent component of the polishing target object can also be measured by the following method.

<Component Analysis by ICP Emission Spectroscopy Plasma>
1. Preparation of Sample A
   (a) While staring a specimen (used abrasive slurry) with a stirrer or the like, collect 1 mL thereof.
   (b) Add 5 mL of hydrofluoric acid for atomic absorption.
   (c) Elute silica by ultrasonic dispersion.
   (d) Allow the resultant product at room temperature for 30 minutes.
   (e) Add ultrapure water to be the total amount of 50 mL.

The specimen liquid prepared in accordance with the above procedure is referred to as sample A.
2. Quantification of Components
   (a) Filtrate sample A with a membrane filter (hydrophilic PTFE).
   (b) Measure the emission line (spectrum) of the filtrate using an inductively coupled plasma emission spectrometer “ICP-AES” (manufactured by SII NanoTechnology Inc).
   (c) Calculate the kind and the content of the component elements by the calibration curve method of the standard addition method.

In the present invention, the phrase “inactivating metal ions” refers to changing metal ions to a form not to interact with the abrasive component or the constituent component of a polishing target object, thereby preventing gelation or aggregation.

Further, for changing metal ions into a form not to interact with the abrasive component or the constituent component of a polishing target object, it is preferable that metal ions form complex(es).

In the present invention, the term “complex” refers to an atomic group formed of one atom or ion as a center around which several other atoms, ions, molecules or atomic groups (these are referred to as “ligands”) are sterically bonded with directionality.

Among the complexes, those with the atom or ion at the center is a metal atom or ion is referred to as a “metal complex”, and it is preferable to form a metal complex in the present invention.

In the metal complex, it is considered that the metal atom or ion and the ligand are bonded by a coordinate bond.

The “coordinate bond” refers to a chemical bond by which a bonding electron is provided to a molecular orbital from only one of two atoms forming a bond.

The term “chelate” refers to a coordinate bond between a metal atom or ion and a ligand (polydentate ligand) having a plurality of coordination sites. A complex thus formed is referred to as a “chelate complex”. In the present invention, an additive to be added for forming a chelate complex is referred to as a “chelating agent”.

In general, between a monodentate ligand and a polydentate ligand having comparable coordination abilities, the polydentate ligand tends to form a more stable complex. Therefore, the complex according to the present invention is further preferably a chelate complex.

The chelating agent is not particularly limited as long as it forms a chelate complex with a metal ion dissolved in the used abrasive slurry. Examples thereof include an aminocarboxylic acid-based chelating agent, a phosphonic acid-based chelating agent, and a polyvalent carboxylic acid-based chelating agent.

Further, the chelating agent may have an effect as an acidity regulator. That is, in the dispersion step described later, the chelating agent may be selected to make the pH value of the used abrasive slurry at 25° C. fall into the range of 5 to 11.

Examples of the aminocarboxylic acid-based chelating agent include ethylenediaminetetraacetic acid (EDTA), nitrilotriacetic acid (NTA), N,N-bis(2-hydroxyethyl) glycine (HEG), N-(2-hydroxyethyl) iminodiacetic acid (HEIDA), hydroxyethylethylenediaminetetraacetic acid (HEDTA), diethylenetriaminepentaacetic acid (DTPA), hydroxyethylethylenediaminetriacetic acid (HEDTA), methylglycinediacetic acid (MGDA), glutamic acid diacetic acid (GLDA), aspartic acid diacetic acid (ASDA), ethylenediaminesuccinic acid (EDDS), hydroxyiminodisuccinic acid (HIDS), iminodisuccinic acid (IDS), and salts (alkali metal salts such as sodium salts) of the foregoing.

Examples of the phosphonic acid-based chelating agent include hydroxyethylidenediphosphonic acid (HEDP), nitrilotrismethylenephosphonic acid (NTMP), phosphonobutanetricarboxylic acid (PBTC), ethylenediaminetetramethylenephosphonic acid (EDTMP), and salts thereof (alkali metal salts such as sodium salts).

Examples of the polyvalent carboxylic acid-based chelating agent include acetic acid, adipic acid, monochloroacetic acid, oxalic acid, succinic acid, oxydisuccinic acid, carboxymethylsuccinic acid, carboxymethyloxysuccinic acid, glycolic acid, diglycolic acid, lactic acid, tartaric acid, carboxymethyltartaric acid, citric acid, malic acid, gluconic acid, and salts thereof (alkali metal salts such as sodium salts).

These chelating agents may be used alone or in combination of two or more.

Among these, ethylenediaminetetraacetic acid, nitrilotriacetic acid, N,N-bis(2-hydroxyethyl)glycine, citric acid, tartaric acid, or a salt of any of these is preferable from the viewpoint of easily forming a chelate complex with a metal ion dissolved in the used abrasive slurry.

The addition amount of the chelating agent is preferably within the range of 0.2 to 50.0 molar equivalents, and further preferably within the range of 0.5 to 10.0 molar equivalents, with respect to the total molar amount of metal ions dissolved in the used abrasive slurry.

(5) Dispersion Step

In the dispersion step, the abrasive component and the constituent component of the polishing target object contained in the used abrasive slurry are dispersed.

By sufficiently dispersing the abrasive component and the constituent component of the polishing target object, the abrasive component and the constituent component of the polishing target object can be sufficiently separated, and the abrasive component can be efficiently collected.

In FIG. 2, the steps (A-3) and (A-4) are steps of dispersing the abrasive component and the constituent component of the polishing target object in the used abrasive slurry with the metal ions inactivated in the inactivation step.

In the step (A-3), it is preferable to adjust the pH value of used abrasive slurry (after the inactivation step) 18 by adding an acidity regulator from an acidity regulator supply tank 16b, if necessary. In addition, it is preferable to improve the dispersibility by adding a dispersant from a dispersant supply tank 16c as necessary.

Then, a dispersion apparatus such as the stirrer 15 is used to disperse the abrasive component and the constituent component of the polishing target object to the extent that they can be easily separated.

In this manner, in the step (A-4), used abrasive slurry (after the dispersion step) 19 in which the abrasive component and the constituent component of the polishing target object are sufficiently dispersed is obtained.

The dispersion method is not particularly limited, but it is preferable to perform dispersion by ultrasonic wave emission, mechanical stirring, or pressurization.

In the dispersion by ultrasonic wave emission, vacuum bubbles generated by applying ultrasonic vibration to the used abrasive slurry burst in the slurry. This large impact disperses aggregates of the abrasive component and the constituent component of the polishing target object.

In the dispersion by mechanical stirring, by moving a rotating blade at a high speed in the used abrasive slurry, aggregates of the abrasive component and the constituent component of the polishing target object are dispersed.

In the dispersion by pressurization, a high pressure is applied to the used abrasive slurry, thereby dispersing aggregates of the abrasive component and constituent component of the polishing target object.

In the dispersion step, the pH value of the used abrasive slurry at 25° C. is preferably within the range of 5 to 11, and an acidity regulator may be added for the purpose of adjusting the pH value to be in the above range.

In the dispersion step, a dispersant may be added.

As the acidity regulator and the dispersant, those used in the preparation step of the unused abrasive slurry described above can be used.

The disperser is not particularly limited, and examples thereof include typical stirrer, homogenizer (ultrasonic type, stirring type, or pressure type), and wet ball mill.

(6) Separation Step

In the separation step, the abrasive component and the constituent component of the polishing target object dispersed in the dispersion step are separated.

In FIG. 3, steps (B-1) and (B-2) are steps of separating the abrasive from the used abrasive slurry subjected to the dispersion in the dispersion step.

In the separation step, a natural sedimentation method, a centrifugation method, a coagulation-sedimentation method in which a salt is added to perform sedimentation separation, a filter filtration method, or a coagulation-sedimentation method in which a pH value is adjusted to perform sedimentation separation can be appropriately used. Among them, the natural sedimentation method is preferable.

The used abrasive slurry (after the dispersion step) 19 subjected to the dispersion in the dispersion step is then preferably separated by a natural sedimentation method in the step (B-1) of FIG. 3 by utilizing the difference in density or particle diameter between the abrasive component and the constituent component of the polishing target object. After sedimentation of the abrasive component, supernatant 21 containing the constituent component of the polishing target object is discharged by a tube 24 for supernatant liquid discharge and a pump 25. In the step (B-2) of FIG. 3, the abrasive component separated from the constituent component of the polishing target object is concentrated to obtain concentrated abrasive slurry 20.

Examples of the method for separating the abrasive component and the constituent component of the polishing target object contained in the used abrasive slurry include natural sedimentation, centrifugation, coagulation sedimentation with addition of a salt, and filtration with a filter, and coagulation sedimentation with adjustment of the pH value.

Among them, the natural sedimentation method is preferably used from the viewpoint that the constituent component of the polishing target object is less likely to enter the inside of the aggregate of the abrasive component. However, in the case of the abrasive slurry having a relatively small particle diameter such as cerium oxide, time required for the separation step can be shortened by intentionally aggregating it and thereby increasing the sedimentation rate. In the present invention, a coagulation-sedimentation method or a centrifugation method may be used to the extent that effects are not impaired. Hereinafter, the coagulation-sedimentation method and the centrifugation method will be described.

(6.1) Coagulation-Sedimentation Method

In the coagulation-sedimentation method, a divalent alkaline earth metal salt or a monovalent alkali metal salt is added as an inorganic salt to a dispersion-treated abrasive slurry. Then, the abrasive component is separated from the constituent component of the polishing target object and concentrated.

Specifically, a divalent alkaline earth metal salt is added as an inorganic salt to the used abrasive slurry after the dispersion step, and the abrasive component is separated from the constituent component of the polishing target object and concentrated. At this time, the pH value of the used abrasive slurry at 25° C. is preferably in the range of 6.5 or more and less than 10.0.

As a result, only the abrasive component is aggregated (coagulated) and precipitated, and most of the constituent component of the polishing target object can be present in the supernatant, so that the aggregate can be separated. Furthermore, separation of the abrasive component and the constituent component of the polishing target object and concentration of the abrasive slurry can be performed at the same time. Hereinafter, the abrasive slurry that has been concentrated may be referred to as “concentrated abrasive slurry”.

The alkaline earth metal salt is used as an aggregating agent for selectively aggregating and precipitating the abrasive component contained in the used abrasive slurry.

The acidity regulator used for adjusting the pH value may be the same as the acidity regulator described above.

(Divalent Alkaline Earth Metal Salt)

In the present invention, the inorganic salt used for the aggregation of the abrasive component is preferably a divalent alkaline earth metal salt.

Examples of the divalent alkaline earth metal salt include a calcium salt, a barium salt, a beryllium salt, and a magnesium salt. Among these, a magnesium salt is preferable from the viewpoint of being able to further exhibiting the effects of the present invention.

The magnesium salt is not limited as long as it functions as an electrolyte. Provided that from the viewpoint of high solubility in water, magnesium chloride, magnesium bromide, magnesium iodide, magnesium sulfate, magnesium acetate and the like are preferable. Magnesium chloride or magnesium sulfate is more preferable from the viewpoint that the fluctuation of the pH value of the solution is small and the treatment of the precipitated abrasive component and the waste liquid is easy.

(Method for Adding Divalent Alkaline Earth Metal Salt)

A method for adding the magnesium salt that is a divalent alkaline earth metal salt will be described.

a) Concentration of Magnesium Salt

Powder of the magnesium salt to be added may be supplied directly to the used abrasive slurry after the dispersion step. Alternatively, it may be dissolved in a solvent such as water and then added to the used abrasive slurry after the dispersion step. Provided that from the viewpoint of being able to uniformly added to the used abrasive slurry, it is preferable to dissolve it in a solvent and then added to the used abrasive slurry.

The concentration of the solution of the magnesium salt to be added to the used abrasive slurry is preferably within the range of 0.5 to 50 mass %. The concentration thereof is more preferably in the range of 1 to 10 mass % from the viewpoint of small variation in the pH value of the system and efficient separation from the constituent component of the polishing target object.

b) Addition Temperature of Magnesium Salt

The temperature at the time of adding the magnesium salt can be appropriately selected as long as it is in the range of the temperature at which the used abrasive slurry freezes to 90° C. However, from the viewpoint of efficiently performing separation from the constituent component of the polishing target object, the temperature is preferably within the range of 10 to 40° C., and more preferably within the range of 15 to 35° C.

c) Addition Rate of Magnesium Salt

The rate at which the magnesium salt is added is preferably adjusted so that the concentration of magnesium in the used abrasive slurry is uniform without becoming locally high. The addition amount per minute is preferably 20 mass % or less and more preferably 10 mass % or less of the total addition amount.

d) pH Value at Addition Time of Magnesium Salt

It is preferable that the separation and the concentration are performed with the pH value of the used abrasive slurry at 25° C. being 6.5 or more and less than 10.0.

e) Stirring after Addition of Magnesium Salt

After addition of the magnesium salt, the stirring is continued preferably for at least 10 minutes or more, and more preferably for 30 minutes or more. The aggregation of the abrasive component is started at the same time as the addition of the magnesium salt, but the aggregation state becomes uniform in the entire system by maintaining the stirring state. Then, the particle size distribution of the aggregate becomes narrow, and the separation thereafter becomes easy.

The concentration is preferably performed so that the concentration of the abrasive component is in the range of 0.1 to 40 mass %.

By setting the concentration of the abrasive component to 0.1 mass % or more, a regenerated abrasive slurry having high polishing performance can be obtained. In addition, by setting the concentration thereof to 40 mass % or less, a regenerated abrasive slurry having an appropriate concentration can be obtained without a filter being clogged.

(6.2) Centrifugation Method

The centrifugation method is a method in which a sufficient centrifugal force is applied to the dispersion-treated abrasive slurry to separate the abrasive component from the constituent component of the polishing target object and concentrate same.

Specifically, the used abrasive slurry after the dispersion step is filled in a centrifuge tube (tube), and then the centrifuge tube is placed in a rotor. Next, for example, after being rotated with a centrifugal force of 1,000 G for one minute, the centrifuge tube is taken out from the rotor, and the sediment and the supernatant in the centrifuge tube are separated.

Examples of the device that performs centrifugation include an angle rotor in which a tube is disposed at a predetermined angle, a swing rotor in which the angle of a tube is variable and the tube becomes horizontal or substantially horizontal during centrifugation, and the like.

(7) Regeneration Step

In the regeneration step, regenerated abrasive slurry containing the abrasive component is prepared.

Using the abrasive component separated in the separation step, abrasive slurry can be regenerated in the same manner as the aforementioned unused abrasive slurry. The obtained abrasive slurry is referred to as “regenerated abrasive slurry”.

In FIG. 3, the steps (B-3) and (B-4) are steps of regenerating abrasive slurry from the abrasive component separated in the separation step.

In step (B-3) of FIG. 3, to the concentrated abrasive slurry 20 separated and concentrated in the separation step, an acidity regulator from the acidity regulator supply tank 16b, a dispersant from the dispersant supply tank 16c, water from a water tank (not illustrated) and/or the like are added as necessary (component adjustment liquid 22). As a result, the component adjustment is performed, and regenerated abrasive slurry 23 is obtained.

The addition of the acidity regulator and the dispersant is not essential, and can be omitted. However, the concentrated abrasive slurry 20 containing the separated and concentrated abrasive component may contain the constituent component of the polishing target object, an ion component eluted from the constituent component of the polishing target object, a metal ion component entered in the polishing step, and the like. In such a case, an acidity regulator or a dispersant which interacts with them is added. Then, it is preferable to adjust the pH value of the regenerated abrasive slurry at 25° C. to be within the range of 6.0 to 10.5.

In the regeneration step, it is preferable to further adjust the particle size distribution of the abrasive component contained in the regenerated abrasive slurry.

In particular, in the case where the abrasive component is aggregated and collected using a magnesium salt or the like, re-dispersion is preferably performed in order to loosen the aggregated abrasive component. Note that it is more preferable that the re-dispersion achieve a particle size distribution similar to that at the time of preparation of unused abrasive slurry.

Examples of the method for re-dispersing the aggregated abrasive component include a method of disintegrating the aggregated abrasive component using a disperser or the like. Examples of the disperser include homogenizers (ultrasonic type, stirring type, and pressure type) and medium stirring mills such as a sand mill and a bead mill. In particular, an ultrasonic homogenizer is preferably used.

Ultrasonic homogenizers are commercially available from, for example, SMT Co., Ltd., Ginsen Co., Ltd., Taitec Corporation, BRANSON Co., Ltd, Kinematica Corporation, NISSEI Corporation, and the like. Examples of the ultrasonic homogenizers include “UDU-1” and “UH-600MC” (both manufactured by SMT Co., Ltd), “GSD600CVP” (manufactured by Ginsen Co., Ltd.), and “RUS600TCVP” (manufactured by NISSEI Corporation). The frequency of the ultrasonic wave is not particularly limited.

Examples of the circulation-type apparatus in which mechanical stirring and ultrasonic wave emission are simultaneously performed in parallel include “UDU-1” and “UH-600MC” (manufactured by SMT Co., Ltd), “GSD600RCVP” and “GSD1200RCVP” (manufactured by Ginsen Co., Ltd), and “RUS600TCVP” (manufactured by NISSEI Corporation). However, the apparatus is not limited to these.

Thus, high-quality regenerated abrasive slurry can be obtained.

3. Abrasive Slurry Regeneration System

An abrasive slurry regeneration system of the present invention includes: a tank where at least a used abrasive slurry containing an abrasive component and a constituent component of a polishing target object discharged from a polishing machine is collected; a tank from which a component that inactivates a metal ion(s) is supplied to the used abrasive slurry; a disperser that disperses the abrasive component and the constituent component of the polishing target object contained in the used abrasive slurry; a separator that separates the abrasive component and the constituent component of the polishing target object contained in the used abrasive slurry to remove the constituent component of the polishing target object; and a tank from which a component to be contained in a regenerated abrasive slurry is supplied.

The abrasive slurry regeneration system of the present invention is a system for carrying out the abrasive slurry regeneration method of the present invention. The abrasive slurry reclamation system of the present invention includes means, apparatuses (devices) and/or the like for carrying out the aforementioned steps of the regeneration method. The means, the apparatuses and/or the like may be integrally provided in one apparatus, or may be in the form of being separately arranged.

The apparatus that disperses the abrasive component and the constituent component of the polishing target object contained in the used abrasive slurry preferably has a device that emits ultrasonic waves, a device that performs mechanical stirring, or a device that performs pressurization.

Examples of such an apparatus include an ordinary stirrer, homogenizer (an ultrasonic type, a stirring type, or a pressure type), and a wet-type ball mill. Among these, from the viewpoint of contamination and strength, a homogenizer is preferable.

Further, the apparatus that separates the abrasive component and the constituent component of the polishing target object contained in the used abrasive slurry preferably has a device that performs the separation by natural sedimentation, centrifugation, coagulation sedimentation with addition of a salt, filtration, or coagulation sedimentation with adjustment of the pH value.

### EXAMPLES

Hereinafter, the present invention will be specifically described with Examples, but the present invention is not limited thereto. In Examples, “part(s)” or “%” means “part(s) by mass” or “% by mass” (mass %) unless otherwise specified.

In the following Examples, operation was performed at room temperature (25° C.) unless otherwise specified.

1. Preparation of Used Abrasive Slurry

Used abrasive slurry was prepared in accordance with manufacturing steps below.

(1) Preparation of Unused Abrasive Slurry

An acrylic acid-maleic acid copolymer as a dispersant was added to pure water, and then stirred for 5 minutes. While it was being stirred, cerium oxide (E21, manufactured by Mitsui Chemicals, Inc) was put, and the mixture was stirred for 30 minutes. Thereafter, the mixture was dispersed with an ultrasonic homogenizer (manufactured by BRANSON Co., Ltd) to prepare 50 L of unused abrasive slurry.

The cerium oxide was added to be 10 mass % with respect to the total mass of unused abrasive slurry, and the dispersant was added to be 5 mass % with respect to the total mass of the cerium oxide.

Thereafter, ammonium water as an acidity regulator was used to adjust the pH value of the unused abrasive slurry at 25° C. to 8.5. The pH value was measured using a Lacom tester desktop pH meter “pH1500” (manufactured by As One Corporation).

The electrical conductivity of the unused abrasive slurry at 25° C. was measured using a compact electrical conductivity meter “LAQUAtwin B-771” (manufactured by HORIBA, Ltd). It was 1.0 mS/cm. The mean particle size (D50) thereof was measured using a particle size distribution analyzer “LA-950V2” (HORIBA, Ltd). It was 0.96 μm.

2. Polishing Step

An aluminosilicate glass substrate was polished under the following conditions. An aluminosilicate glass substrate containing 60 mass % of silicon oxide, 15 mass % of oxides of alkali metal and alkaline earth metal, and 25 mass % of aluminum oxide and other components was used.

In the polishing step, which is shown in FIG. 1, with a double-sided polishing machine, while the prepared unused abrasive slurry was supplied to a polishing target surface, the polishing target surface was polished with a polishing cloth. The unused abrasive slurry was circulated and supplied at a flow rate of 5 L/min to perform polishing. As the polishing target object, an aluminosilicate glass substrate having a diameter of 65 mm and a thickness of 5 mm was used, and as the polishing cloth, a polishing cloth made of polyurethane was used.

The polishing was performed for 30 minutes with the polishing pressure on the polishing surface set to 9. 8 kPa (100g/cm²) and the rotation speed of a polishing tester set to 100 min⁻¹ (rpm). One hundred sheets of glass for one patch were set.

During the polishing, the pH value was measured as appropriate. When the pH value was more than 8.5, an aqueous sulfuric acid solution was added to adjust the pH value to 8.5 or less but not less than 7.0. After completion of the polishing, the used abrasive slurry a that reached the criterion for disposal and the used abrasive slurry b as washing liquid containing the abrasive were collected, and these were combined to obtain used abrasive slurry.

The collected used abrasive slurry was subjected to component analysis by the abovementioned ICP emission spectroscopy plasma. The content of the glass component was 10 g/L with respect to the total mass of the used abrasive slurry. As the metal ions, aluminum ion (Al³⁺), calcium ion (Ca²⁺), and magnesium ion (Mg²⁺) were detected. The molar concentration of the sum of these metal ions was 15.0 mM (mmol/L).

3. Preparation of Regenerated Abrasive Slurry

[Preparation of Regenerated Abrasive Slurry 1]

1.0 L of the collected used abrasive slurry was filtered using a 100 μm mesh filter to remove coarse foreign substances.

Next, disodium ethylenediaminetetraacetate was added as a chelating agent. The chelating agent was added so as to be a molar concentration of 15.0 mM (mmol/L) to the used abrasive slurry, and the mixture was stirred.

Thereafter, aqueous ammonia as an acidity regulator was added to the used abrasive slurry (after the inactivation step) to adjust the pH value to 8.0. Thereafter, the dispersion was performed using an ultrasonic homogenizer “UP400S” (manufactured by Hielscher).

After the ultrasonic dispersion, the used abrasive slurry (after the dispersion step) was allowed to stand for 1 hour, and was separated into the supernatant and the sediment by the natural sedimentation method. The supernatant was discharged, and 0.1 L of the abrasive slurry (concentrated abrasive slurry) containing the sediment was collected. In this manner, removal of the glass component and concentration of the cerium oxide component were performed.

An acrylic acid-maleic acid copolymer as a dispersant and an aqueous acetic acid solution as an acidity regulator were added to the obtained concentrated abrasive slurry to adjust the pH value at 25° C. to 8.5.

Thereafter, the mixture was stirred for 30 minutes using a dispersion stirrer, and then the sediment was dispersed and loosened using an ultrasonic homogenizer (manufactured by BRANSON Co., Ltd).

After completion of the dispersion, filtration was performed with a 10 μm depth filter to obtain a regenerated abrasive slurry 1 containing cerium oxide.

[Preparation of Regenerated Abrasive Slurries 2, 3 and 24 to 27]

The kind of chelating agent added in the inactivation step in the preparation of the regenerated abrasive slurry 1 was changed as shown in TABLE I or TABLE II. The kind of acidity regulator added in the dispersion step in the preparation of the regenerated abrasive slurry 1 was changed as shown in TABLE I or TABLE II. Other than the above, regenerated abrasive slurries 2, 3 and 24 to 27 were prepared by the same method.

[Preparation of Regenerated Abrasive Slurries 4 to 10]

The kind and the addition amount of chelating agent added in the inactivation step in the preparation of the regenerated abrasive slurry 1 were changed as shown in TABLE I. Other than the above, regenerated abrasive slurries 4 to 10 were prepared by the same method. Regarding the addition amount, the chelating agent was added so as to be the molar concentration shown in TABLE I to the used abrasive slurry.

[Preparation of Regenerated Abrasive Slurries 11 to 17, 19 and 20]

The kind of acidity regulator added in the dispersion step and the pH value of the used abrasive slurry in the dispersion step in the preparation of the regenerated abrasive slurry 7 were changed as shown in Table 1 or TABLE II. Other than the above, regenerated abrasive slurries 11 to 17, 19 and 20 were prepared by the same method.

[Preparation of Regenerated Abrasive Slurry 18]

A regenerated abrasive slurry 18 was prepared by the same method as that for the preparation of the regenerated abrasive slurry 7 except that no acidity regulator was added in the dispersion step.

[Preparation of Regenerated Abrasive Slurries 21 to 23]

The conditions in the polishing step were changed. In collected three kinds of used abrasive slurries, the molar concentrations of the sum of the metal ions by the component analysis by the ICP emission spectrometry plasma were 7.0 mM (mmol/L), 10.0 mM (mmol/L), and 20.0 mM (mmol/L).

These three kinds of used abrasive slurries were used in the method same as that for the preparation of the regenerated abrasive slurry 7. In addition, the addition amount of the chelating agent added in the inactivation step was changed as shown in TABLE II. Other than these, regenerated abrasive slurries 21 to 23 were prepared by the same method. Regarding the addition amount, the chelating agent was added so as to be the molar concentration shown in TABLE II to the used abrasive slurry.

[Preparation of Regenerated Abrasive Slurry 28]

A regenerated abrasive slurry 28 was prepared by the same method as that for the preparation of the regenerated abrasive slurry 1 except that no chelating agent was added in the inactivation step.

[Preparation of Regenerated Abrasive Slurry 29]

Aqueous ammonia as an acidity regulator was added to the used abrasive slurry (after the inactivation step) to adjust the pH value to 8.0 in the method same as that for the preparation of the regenerated abrasive slurry 7. Thereafter, polyacrylic acid (PAA) as a dispersant was added to be 2.5 mass % with respect to the total mass of the used abrasive slurry. The dispersion was performed using an ultrasonic homogenizer “UP400S” (manufactured by Hielscher). Other than the above, a regenerated abrasive slurry 29 was prepared by the same method.

[Preparation of Regenerated Abrasive Slurries 30 to 33]

The kind of dispersant added in the dispersion step in the preparation of the regenerated abrasive slurry 29 was changed as shown in TABLE II. Other than the above, regenerated abrasive slurries 30 to 33 were prepared by the same method.

[Preparation of Regenerated Abrasive Slurry 34]

Aqueous ammonia as an acidity regulator was added to the used abrasive slurry (after the inactivation step) to adjust the pH value to 8.0 in the method same as that for the preparation of the regenerated abrasive slurry 7. Thereafter, a regenerated abrasive slurry 34 was prepared by the same method except that the dispersion was performed using a stirrer “HG-200” (manufactured by AS ONE Corporation).

[Preparation of Regenerated Abrasive Slurry 35]

Aqueous ammonia as an acidity regulator was added to the used abrasive slurry (after the inactivation step) to adjust the pH value to 8.0 in the method same as that for the preparation of the regenerated abrasive slurry 7. Thereafter, the dispersion was performed using a pressure-type homogenizer “LAB1000” (manufactured by SMT Co., Ltd). Other than the above, a regenerated abrasive slurry 35 was prepared by the same method.

[Preparation of Regenerated Abrasive Slurry 36]

Aqueous ammonia as an acidity regulator was added to the used abrasive slurry (after the inactivation step) to adjust the pH value to 8.0 in the method same as that for the preparation of the regenerated abrasive slurry 7. Thereafter, a regenerated abrasive slurry 36 was prepared by the same method except that the dispersion was not performed.

TABLE I and TABLE II show the preparation conditions of the respective regenerated abrasive slurries.

The terms used in TABLE I and TABLE II are as follows.

The “molar concentration ratio” indicates the ratio (proportion) of the molar concentration of the chelating agent to the molar concentration of the metal ions.

The “-” therein indicates that no addition or treatment was performed.

(Chelating Agent)

EDTA-2Na: Disodium Ethylenediaminetetraacetate

EDTA-4Na: Tetrasodium Ethylenediaminetetraacetate

EDTA-2K: Dipotassium Ethylenediaminetetraacetate

NTA: Nitrilotriacetic Acid

HEG: N,N-bis(2-hydroxyethyl) glycine

(Acidity Regulator)

NH4OH: Ammonium Hydroxide (Aqueous Ammonia)

H2SO4: Aqueous Sulfuric Acid Solution

TEA: Triethanolamine

NaOH: Aqueous Sodium Hydroxide Solution

KOH: Aqueous Potassium Hydroxide Solution

(Dispersant)

PAA: Polyacrylic Acid (Water-soluble Anionic Dispersant)

PANa: Sodium Polyacrylate (Water-soluble Anionic Dispersant)

PAMNa: Sodium Polyacrylate Maleate (Water-soluble Anionic Dispersant)

*1: Lauryltrimethylammonium Chloride (Water-soluble Cationic Dispersant)

*2: N,N-dimethyl-N-alkyl-N-carboxymethylammonium Betaine (Water-soluble Amphoteric Dispersant)

TABLE I

| | SLURRY | | | | | | | | | |
|---|---|---|---|---|---|---|---|---|---|---|
| | COLLECTION STEP | | INACTIVATION STEP | | | | | | | |
| | METAL ION | | CHERATING AGENT | | | DISPERSION STEP | | | | |
| REGENERATED | | MOLAR | | MOLAR | MOLAR | | | DISPERSANT | | |
| ABRASIVE | | CONCEN- | | CONCEN- | CONCEN- | | | | ADDITION | |
| SLURRY | | TRATION | | TRATION | TRATION | DISPERSION | ACIDITY | | AMOUNT | pH |
| NO. | KIND | [mM] | KIND | [mM] | RATIO | METHOD | REGULATOR | KIND | [mass %] | VALUE |
| 1 | Al³⁺, Ca²⁺, | 15.0 | EDTA-2Na | 15.0 | 1.0 | ULTRASONIC | NH₄OH | — | — | 8.0 |
| | Mg²⁺ | | | | | | | | | |
| 2 | Al³⁺, Ca²⁺, | 15.0 | EDTA-4Na | 15.0 | 1.0 | ULTRASONIC | H₂SO₄ | — | — | 8.0 |
| | Mg²⁺ | | | | | | | | | |
| 3 | Al³⁺, Ca²⁺, | 15.0 | EDTA-2K | 15.0 | 1.0 | ULTRASONIC | NH₄OH | — | — | 8.0 |
| | Mg²⁺ | | | | | | | | | |
| 4 | Al³⁺, Ca²⁺, | 15.0 | TRISODIUM | 1.5 | 0.1 | ULTRASONIC | _{—} | — | — | 8.0 |
| | Mg²⁺ | | CITRATE | | | | | | | |
| 5 | Al³⁺, Ca²⁺, | 15.0 | TRISODIUM | 3.0 | 0.2 | ULTRASONIC | NH₄OH | — | — | 8.0 |
| | Mg²⁺ | | CITRATE | | | | | | | |
| 6 | Al³⁺, Ca²⁺, | 15.0 | TRISODIUM | 7.5 | 0.5 | ULTRASONIC | NH₄OH | — | — | 8.0 |
| | Mg²⁺ | | CITRATE | | | | | | | |
| 7 | Al³⁺, Ca²⁺, | 15.0 | TRISODIUM | 15.0 | 1.0 | ULTRASONIC | NH₄OH | — | — | 8.0 |
| | Mg²⁺ | | CITRATE | | | | | | | |
| 8 | Al³⁺, Ca²⁺, | 15.0 | TRISODIUM | 150.0 | 10.0 | ULTRASONIC | NH₄OH | — | — | 8.0 |
| | Mg²⁺ | | CITRATE | | | | | | | |
| 9 | Al³⁺, Ca²⁺, | 15.0 | TRISODIUM | 750.0 | 50.0 | ULTRASONIC | NH₄OH | — | — | 8.0 |
| | Mg²⁺ | | CITRATE | | | | | | | |
| 10 | Al³⁺, Ca²⁺, | 15.0 | TRISODIUM | 1200.0 | 80.0 | ULTRASONIC | NH₄OH | — | — | 8.0 |
| | Mg²⁺ | | CITRATE | | | | | | | |
| 11 | Al³⁺, Ca²⁺, | 15.0 | TRISODIUM | 15.0 | 1.0 | ULTRASONIC | CITRIC ACID | — | — | 8.0 |
| | Mg²⁺ | | CITRATE | | | | | | | |
| 12 | Al³⁺, Ca²⁺, | 15.0 | TRISODIUM | 15.0 | 1.0 | ULTRASONIC | CITRIC ACID | — | — | 4.0 |
| | Mg²⁺ | | CITRATE | | | | | | | |
| 13 | Al³⁺, Ca²⁺, | 15.0 | TRISODIUM | 15.0 | 1.0 | ULTRASONIC | CITRIC ACID | — | — | 5.0 |
| | Mg²⁺ | | CITRATE | | | | | | | |
| 14 | Al³⁺, Ca²⁺, | 15.0 | TRISODIUM | 15.0 | 1.0 | ULTRASONIC | CITRIC ACID | — | — | 6.0 |
| | Mg²⁺ | | CITRATE | | | | | | | |
| 15 | Al³⁺, Ca²⁺, | 15.0 | TRISODIUM | 15.0 | 1.0 | ULTRASONIC | NaOH | — | — | 10.0 |
| | Mg²⁺ | | CITRATE | | | | | | | |
| 16 | Al³⁺, Ca²⁺, | 15.0 | TRISODIUM | 15.0 | 1.0 | ULTRASONIC | NaOH | — | — | 11.0 |
| | Mg²⁺ | | CITRATE | | | | | | | |
| 17 | Al³⁺, Ca²⁺, | 15.0 | TRISODIUM | 15.0 | 1.0 | ULTRASONIC | NaOH | — | — | 12.0 |
| | Mg²⁺ | | CITRATE | | | | | | | |
| 18 | Al³⁺, Ca²⁺, | 15.0 | TRISODIUM | 15.0 | 1.0 | ULTRASONIC | — | — | — | 7.5 |
| | Mg²⁺ | | CITRATE | | | | | | | |

TABLE II

| | SLURRY | | | | | | | | | |
|---|---|---|---|---|---|---|---|---|---|---|
| | COLLECTION STEP | | INACTIVATION STEP | | | | | | | |
| | METAL ION | | CHERATING AGENT | | | DISPERSION STEP | | | | |
| REGENERATED | | MOLAR | | MOLAR | MOLAR | | | DISPERSANT | | |
| ABRASIVE | | CONCEN- | | CONCEN- | CONCEN- | DISPER- | ACIDITY | | ADDITION | |
| SLURRY | | TRATION | | TRATION | TRATION | SION | REGU- | | AMOUNT | pH |
| NO. | KIND | [mM] | KIND | [mM] | RATIO | METHOD | LATOR | KIND | [mass %] | VALUE |
| 19 | Al³⁺, Ca²⁺, | 15.0 | TRISODIUM | 15.0 | 1.0 | ULTRA- | TEA | — | — | 8.0 |
| | Mg²⁺ | | CITRATE | | | SONIC | | | | |
| 20 | Al³⁺, Ca²⁺, | 15.0 | TRISODIUM | 15.0 | 1.0 | ULTRA- | KOH | — | — | 8.0 |
| | Mg²⁺ | | CITRATE | | | SONIC | | | | |
| 21 | Al³⁺, Ca²⁺, | 7.0 | TRISODIUM | 7.0 | 1.0 | ULTRA- | NH₄OH | — | — | 8.0 |
| | Mg²⁺ | | CITRATE | | | SONIC | | | | |
| 22 | Al³⁺, Ca²⁺, | 10.0 | TRISODIUM | 20.0 | 2.0 | ULTRA- | NH₄OH | — | — | 8.0 |
| | Mg²⁺ | | CITRATE | | | SONIC | | | | |
| 23 | Al³⁺, Ca²⁺, | 20.0 | TRISODIUM | 30.0 | 1.5 | ULTRA- | NH₄OH | — | — | 8.0 |
| | Mg²⁺ | | CITRATE | | | SONIC | | | | |
| 24 | Al³⁺, Ca²⁺, | 15.0 | CITRIC ACID | 15.0 | 1.0 | ULTRA- | NaOH | — | — | 8.0 |
| | Mg²⁺ | | | | | SONIC | | | | |
| 25 | Al³⁺, Ca²⁺, | 15.0 | POTASSIUM | 15.0 | 1.0 | ULTRA- | NH₄OH | — | — | 8.0 |
| | Mg²⁺ | | SODIUM | | | SONIC | | | | |
| | | | TARTRATE | | | | | | | |
| 26 | Al³⁺, Ca²⁺, | 15.0 | NTA | 15.0 | 1.0 | ULTRA- | NH₄OH | — | — | 8.0 |
| | Mg²⁺ | | | | | SONIC | | | | |
| 27 | Al³⁺, Ca²⁺, | 15.0 | HEG | 15.0 | 1.0 | ULTRA- | NH₄OH | — | — | 8.0 |
| | Mg²⁺ | | | | | SONIC | | | | |
| 28 | Al³⁺, Ca²⁺, | 15.0 | — | — | — | ULTRA- | NH₄OH | — | — | 8.0 |
| | Mg²⁺ | | | | | SONIC | | | | |
| 29 | Al³⁺, Ca²⁺, | 15.0 | TRISODIUM | 15.0 | 1.0 | ULTRA- | NH₄OH | PAA | 2.5 | 8.0 |
| | Mg²⁺ | | CITRATE | | | SONIC | | | | |
| 30 | Al³⁺, Ca²⁺, | 15.0 | TRISODIUM | 15.0 | 1.0 | ULTRA- | NH₄OH | PANa | 2.5 | 8.0 |
| | Mg²⁺ | | CITRATE | | | SONIC | | | | |
| 31 | Al³⁺, Ca²⁺, | 15.0 | TRISODIUM | 15.0 | 1.0 | ULTRA- | NH₄OH | PAMNa | 2.5 | 8.0 |
| | Mg²⁺ | | CITRATE | | | SONIC | | | | |
| 32 | Al³⁺, Ca²⁺, | 15.0 | TRISODIUM | 15.0 | 1.0 | ULTRA- | NH₄OH | *1 | 2.5 | 8.0 |
| | Mg²⁺ | | CITRATE | | | SONIC | | | | |
| 33 | Al³⁺, Ca²⁺, | 15.0 | TRISODIUM | 15.0 | 1.0 | ULTRA- | NH₄OH | *2 | 2.5 | 8.0 |
| | Mg²⁺ | | CITRATE | | | SONIC | | | | |
| 34 | Al³⁺, Ca²⁺, | 15.0 | TRISODIUM | 15.0 | 1.0 | STIR | NH₄OH | — | — | 8.0 |
| | Mg²⁺ | | CITRATE | | | | | | | |
| 35 | Al³⁺, Ca²⁺, | 15.0 | TRISODIUM | 15.0 | 1.0 | PRESSURE | NH₄OH | — | — | 8.0 |
| | Mg²⁺ | | CITRATE | | | | | | | |
| 36 | Al³⁺, Ca²⁺, | 15.0 | TRISODIUM | 15.0 | 1.0 | — | NH₄OH | — | — | 8.0 |
| | Mg²⁺ | | CITRATE | | | | | | | |

4. Evaluation

[Removal Rate of Glass Component]

With respect to the collected used abrasive slurries and the prepared regenerated abrasive slurries, the concentration of the abrasive component (cerium oxide) and the concentration of the constituent component (glass component) of the polishing target object were measured by the abovementioned component analysis by ICP emission spectroscopy plasma.

Note that the used abrasive slurries were subjected to the component analysis after being collected but before being subjected to the inactivation (addition of the chelating agent).

Then, the removal rate R (%) of the constituent component (glass component) of the polishing target object was calculated by the following formula.

R(%)=[1−{(a÷b)÷(c÷d)}]×100 (Formula)

The symbols therein represent the following.

R: Removal Rate (%) of Glass Component

a: Concentration (g/L) of Glass Component in Regenerated Abrasive Slurry

b: Concentration (g/L) of Cerium Oxide in Regenerated Abrasive Slurry

c: Concentration (g/L) of Glass Component of Used Abrasive Slurry

d: Concentration (g/L) of Cerium Oxide in Used Abrasive Slurry

The calculated removal rate R (%) of the glass component was evaluated by the following criteria. The “A” or higher (“A” and “AA”) was regarded as passing.

B: The removal rate R of the glass component is less than 50%.

A: The removal ratio R of the glass component is 50% or more but less than 80%.

AA: The removal rate R of the glass component is 80% or more.

TABLE III shows the removal rate R (%) of the glass component of each regenerated abrasive slurry and the evaluation.

TABLE III

| | GLASS | | |
|---|---|---|---|
| REGENERATED | COMPONENT | | |
| ABRASIVE | REMOVAL | | |
| SLURRY NO. | RATE R [%] | EVALUATION | REMARKS |
| 1 | 87.8 | AA | EXAMPLE |
| 2 | 87.1 | AA | EXAMPLE |
| 3 | 85.4 | AA | EXAMPLE |
| 4 | 58.9 | A | EXAMPLE |
| 5 | 75.4 | A | EXAMPLE |
| 6 | 81.8 | AA | EXAMPLE |
| 7 | 84.4 | AA | EXAMPLE |
| 8 | 87.7 | AA | EXAMPLE |
| 9 | 62.9 | A | EXAMPLE |
| 10 | 61.1 | A | EXAMPLE |
| 11 | 87.7 | AA | EXAMPLE |
| 12 | 55.5 | A | EXAMPLE |
| 13 | 62.2 | A | EXAMPLE |
| 14 | 82.5 | AA | EXAMPLE |
| 15 | 81.1 | AA | EXAMPLE |
| 16 | 68.7 | A | EXAMPLE |
| 17 | 62.5 | A | EXAMPLE |
| 18 | 84.4 | AA | EXAMPLE |
| 19 | 81.5 | AA | EXAMPLE |
| 20 | 82.7 | AA | EXAMPLE |
| 21 | 85.2 | AA | EXAMPLE |
| 22 | 85.0 | AA | EXAMPLE |
| 23 | 82.5 | AA | EXAMPLE |
| 24 | 85.2 | AA | EXAMPLE |
| 25 | 82.3 | AA | EXAMPLE |
| 26 | 83.0 | AA | EXAMPLE |
| 27 | 82.7 | AA | EXAMPLE |
| 28 | 22.9 | B | COMPARATIVE |
| | | | EXAMPLE |
| 29 | 92.0 | AA | EXAMPLE |
| 30 | 91.8 | AA | EXAMPLE |
| 31 | 92.2 | AA | EXAMPLE |
| 32 | 90.5 | AA | EXAMPLE |
| 33 | 91.7 | AA | EXAMPLE |
| 34 | 80.5 | AA | EXAMPLE |
| 35 | 82.5 | AA | EXAMPLE |
| 36 | 25.3 | B | COMPARATIVE |
| | | | EXAMPLE |

As can be seen from Examples and Comparative Examples of the present invention, the abrasive slurry regeneration method of the present invention improves the removal rate of a constituent component (glass component) of a polishing target object contained in a used abrasive slurry.

As can be seen from the regenerated abrasive slurries 4, 5, 9 and 10, the addition amount of the chelating agent within the range of 0.2 to 50.0 molar equivalents with respect to the total molar amount of the metal ions dissolved in the used abrasive slurry improves the removal rate of the glass component.

As can be seen from the regenerated abrasive slurries 5, 6, 8 and 9, the addition amount of the chelating agent within the range of 0.5 to 10.0 molar equivalents with respect to the total molar amount of the metal ions dissolved in the used abrasive slurry further improves the removal rate of the glass component.

As can be seen from the regenerated abrasive slurries 7, 34 and 35, dispersing the abrasive component and the constituent component of the polishing target object contained in the used abrasive slurry by ultrasonic wave emission, mechanical stirring or pressurization improves the removal rate of the glass component.

As can be seen from the regenerated abrasive slurries 12, 13, 16 and 17, the pH value of the used abrasive slurry at 25° C. being in the range of 5 to 11 in the dispersion step improves the removal rate of the glass component.

As can be seen from the regenerated abrasive slurries 2, 7, 11 to 17, 19 and 20, the acidity regulator being inorganic acid, carboxylic acid, amine base or hydroxide improves the removal rate of the glass component.

As can be seen from the regenerated abrasive slurries 7 and 29 to 33, adding the dispersant to the used abrasive slurry in the dispersion step improves the removal rate of the glass component. Also, as can be seen therefrom, the dispersant being a water-soluble anionic dispersant or a water-soluble cationic dispersant improves the removal rate of the glass component.

Although embodiments of the present invention have been described and illustrated in detail, the disclosed embodiments are made for purposes of illustration and example only and not limitation. The scope of the present invention should be interpreted by terms of the appended claims.

1. An abrasive slurry regeneration method comprising:
collecting at least a used abrasive slurry containing an abrasive component and a constituent component of a polishing target object discharged from a polishing machine;
inactivating a metal ion dissolved in the used abrasive slurry;
dispersing the abrasive component and the constituent component of the polishing target object contained in the used abrasive slurry;
separating the dispersed abrasive component and constituent component of the polishing target object to remove the constituent component of the polishing target object; and
preparing a regenerated abrasive slurry containing the abrasive component.

2. The abrasive slurry regeneration method according to claim 1, wherein a complex is formed to inactivate the metal ion dissolved in the used abrasive slurry.

3. The abrasive slurry regeneration method according to claim 2, wherein a chelating agent is added to the used abrasive slurry to form the complex.

4. The abrasive slurry regeneration method according to claim 3, wherein the chelating agent contains ethylenediaminetetraacetic acid, citric acid, tartaric acid, nitrilotriacetic acid, N,N-bis(2-hydroxyethyl)glycine and/or salt of any thereof.

5. The abrasive slurry regeneration method according to claim 3, wherein an addition amount of the chelating agent is within a range of 0.2 to 50.0 molar equivalents with respect to a total molar amount of the metal ion dissolved in the used abrasive slurry.

6. The abrasive slurry regeneration method according to claim 3, wherein an addition amount of the chelating agent is within a range of 0.5 to 10.0 molar equivalents with respect to a total molar amount of the metal ion dissolved in the used abrasive slurry.

7. The abrasive slurry regeneration method according to claim 1, wherein ultrasonic wave emission, mechanical stirring and/or pressurization is performed to disperse the abrasive component and the constituent component of the polishing target object contained in the used abrasive slurry.

8. The abrasive slurry regeneration method according to claim 1, wherein in the dispersing, a pH value of the used abrasive slurry at 25° C. is within a range of 5 to 11.

9. The abrasive slurry regeneration method according to claim 1, wherein in the dispersing, an acidity regulator is added to the used abrasive slurry to make a pH value of the used abrasive slurry at 25° C. be within the range of 5 to 11.

10. The abrasive slurry regeneration method according to claim 9, wherein the acidity regulator is inorganic acid, carboxylic acid, amine base and/or hydroxide.

11. The abrasive slurry regeneration method according to claim 1, wherein in the dispersing, a dispersant is added to the used abrasive slurry.

12. The abrasive slurry regeneration method according to claim 11, wherein the dispersant is a water-soluble anionic dispersant, a water-soluble cationic dispersant and/or a water-soluble amphoteric dispersant.

13. The abrasive slurry regeneration method according to claim 1, wherein natural sedimentation, centrifugation, coagulation sedimentation with addition of salt, filtration and/or coagulation sedimentation with adjustment of a pH value is performed to separate the abrasive component and the constituent component of the polishing target object contained in the used abrasive slurry.

14. An abrasive slurry regeneration system comprising:
a tank where at least a used abrasive slurry containing an abrasive component and a constituent component of a polishing target object discharged from a polishing machine is collected;
a tank from which a component that inactivates a metal ion is supplied to the used abrasive slurry;
a disperser that disperses the abrasive component and the constituent component of the polishing target object contained in the used abrasive slurry;
a separator that separates the abrasive component and the constituent component of the polishing target object contained in the used abrasive slurry to remove the constituent component of the polishing target object; and
a tank from which a component to be contained in a regenerated abrasive slurry is supplied.

15. The abrasive slurry regeneration system according to claim 14, wherein the disperser includes a device that emits an ultrasonic wave, performs mechanical stirring and/or performs pressurization.

16. The abrasive slurry regeneration system according to claim 15, wherein the disperser is a homogenizer.

17. The abrasive slurry regeneration system according to claim 14, wherein the separator performs natural sedimentation, centrifugation, coagulation sedimentation with addition of salt, filtration and/or coagulation sedimentation with adjustment of a pH value to perform the separation.
